(19) United States
(12) Patent Application Publication
(10) Pub. No.: US 2008/0005965 A1
(43) Pub. Date: Jan. 10, 2008

(54) System for providing high purity hydrogen and method thereof

(76) Inventor: A. John Speranza, West Hartford, CT (US)

Correspondence Address: CANTOR COLBURN, LLP - PROTON, 55 GRIFFIN ROAD SOUTH, BLOOMFIELD, CT, 06002, US

(21) Appl. No.: 11/267,094

(22) Filed: Nov. 4, 2005

(51) Int. Cl. B01J 8/00

(52) U.S. Cl. 48/127.9

(57) ABSTRACT

The present invention provides a system for providing high purity hydrogen having a hydrogen conversion device having a first outlet and a means for converting a hydrogen precursor into gaseous hydrogen at a predetermined first pressure. A first pressure regulator is fluidly coupled to the hydrogen conversion device outlet where the first regulator has a predetermined operating parameter set at a second pressure. A second pressure regulator is provided having a predetermined operating parameter set at a third pressure where the third pressure is lower than the second pressure. A second hydrogen source containing a first quantity of pressurized hydrogen gas at a fourth pressure is fluidly coupled to the second regulator. Finally, a junction fluidly couples the first and second regulators.

### FIELD OF INVENTION

This disclosure relates generally to a system for providing high purity hydrogen gas to an end use application, and more particularly to a system for supplying high purity hydrogen from a secondary source if impurities are found in the primary hydrogen source.

### BACKGROUND OF THE INVENTION

Modern societies are critically dependent on energy derived from fossil fuels to maintain their standard of living. As more societies modernize and existing modern societies expand, the consumption of fossil fuels continues to increase and the growing dependence worldwide on the use of fossil fuels is leading to a number of problems. First, fossil fuels are a finite resource and concern is growing that fossil fuels will become fully depleted in the foreseeable future. Scarcity raises the possibility that escalating cost could destablize economies. Second, fossil fuels are highly polluting. The greater the combustion of fossil fuels has prompted recognition of global warming and the dangers it poses to the environment. In order to prevent the deleterious effects of fossil fuels, new energy sources are needed.

The desired attributes of a new fuel or energy source include low cost, plentiful supply, renewability, safety, and environmental compatibility. Hydrogen is currently a promising prospect for providing these attributes and offers the potential to greatly reduce our dependence on conventional fossil fuels. Hydrogen is the most abundant element in the universe and offers an inexhaustible fuel source to meet the increasing energy demands of the world. Hydrogen is available from a variety of sources including natural gas, hydrocarbons, organic materials, inorganic hydrides and water. These sources are geographically well distributed around the world and accessible to most of the world's population without the need to import. In addition to being plentiful and widely available, hydrogen is a clean fuel source. Combustion of hydrogen produces water as a by-product. Utilization of hydrogen as a fuel source thus avoids the unwanted generation of carbon and nitrogen based greenhouse gases that are responsible for global warming and the unwanted production of soot and other carbon based pollutants.

The realization of hydrogen as a ubiquitous source of energy ultimately depends on its economic feasibility. Economically viable methods for producing hydrogen as well as efficient means for storing, transferring and consuming hydrogen are needed. Chemical and electrochemical methods have been proposed for the production of hydrogen. The most readily available chemical precursors for hydrogen are organic compounds, primarily hydrocarbons and oxygenated hydrocarbons, and water.

A number of methods have been proposed for the conversion of hydrogen into energy. These methods include combustion, such an internal combustion engine, and electrochemical such as a fuel cell. Each of these methods requires a fairly clean form of hydrogen, free from contaminants. For example, the electrochemical process used in fuel cells may become poisoned if the hydrogen gas stream contains remnant carbon monoxide. This need for high purity hydrogen is not unique to the new engines and devices for the production of energy. Industrial process equipment, such as gas chromatography equipment will suffer deleterious effects if a contaminant is found in the hydrogen gas stream.

Unfortunately, as new forms of hydrogen generation methods are developed, they all have some form of potential for introducing contamination into the gas stream. While existing prior art systems have been used to protect the hydrogen consuming devices and were acceptable for their intended purpose, a new method and system is needed to assure a continuous supply of hydrogen gas with minimal involvement from the process operator.

### SUMMARY OF THE INVENTION

The present invention provides a system for providing high purity hydrogen having a hydrogen conversion device having a first outlet and a means for converting a hydrogen precursor into gaseous hydrogen at a predetermined first pressure. A first pressure regulator is fluidly coupled to the hydrogen conversion device outlet where the first regulator has a predetermined operating parameter set at a second pressure. A second pressure regulator is provided having a predetermined operating parameter set at a third pressure where the third pressure is lower than the second pressure. A second hydrogen source containing a first quantity of pressurized hydrogen gas at a fourth pressure is fluidly coupled to the second regulator. Finally, a junction fluidly couples the first and second regulators.

A method for providing high purity hydrogen is also provided where hydrogen gas is generated from a first precursor. The hydrogen gas is monitored for an impurity level and transferred to a first conduit if the impurity level is below a first operational parameter. The hydrogen gas is transferred to a second conduit if the impurity level is above the first operation parameter. A first pressure reducing regulator coupled to the first conduit is set to a first pressure and hydrogen gas is transferred to a third conduit fluidly coupled to the first regulator opposite the first conduit. Finally, a second pressure reducing regulator fluidly coupled to the third conduit is set to a second pressure.

The above discussed and other features will be appreciated and understood by those skilled in the art from the following detailed description and drawings.

### BRIEF DESCRIPTION OF THE DRAWINGS

Referring now to the drawings, which are meant to be exemplary and not limiting, and wherein like elements are numbered alike:

FIG. 1 is a schematic illustration of the system for providing high purity hydrogen gas in accordance with an embodiment of the invention;

FIG. 2 illustrates a schematic diagram of a partial electrochemical cell showing an electrochemical reaction for use in accordance with an embodiment of the invention;

FIG. 3 illustrates a schematic diagram of a controller use in the system for providing high purity hydrogen gas shown in FIG. 1;

FIG. 4 is a flow diagram of a high purity hydrogen system output control method employed by the controller shown in FIG. 3;

FIG. 5 is a schematic illustration of an alternate embodiment system for providing high purity hydrogen gas in accordance with an embodiment of the invention;

FIG. 6 is a schematic illustration of another alternate embodiment system for providing high purity hydrogen gas in accordance with an embodiment of the invention;

### DESCRIPTION OF PREFERRED EMBODIMENT

Disclosed herein are novel embodiments for a system of providing high purity hydrogen gas having a hydrogen conversion device strategically arranged with a secondary source of hydrogen gas to allow automatic diversion of hydrogen gas in the event a contaminant is detected in the generated hydrogen gas stream.

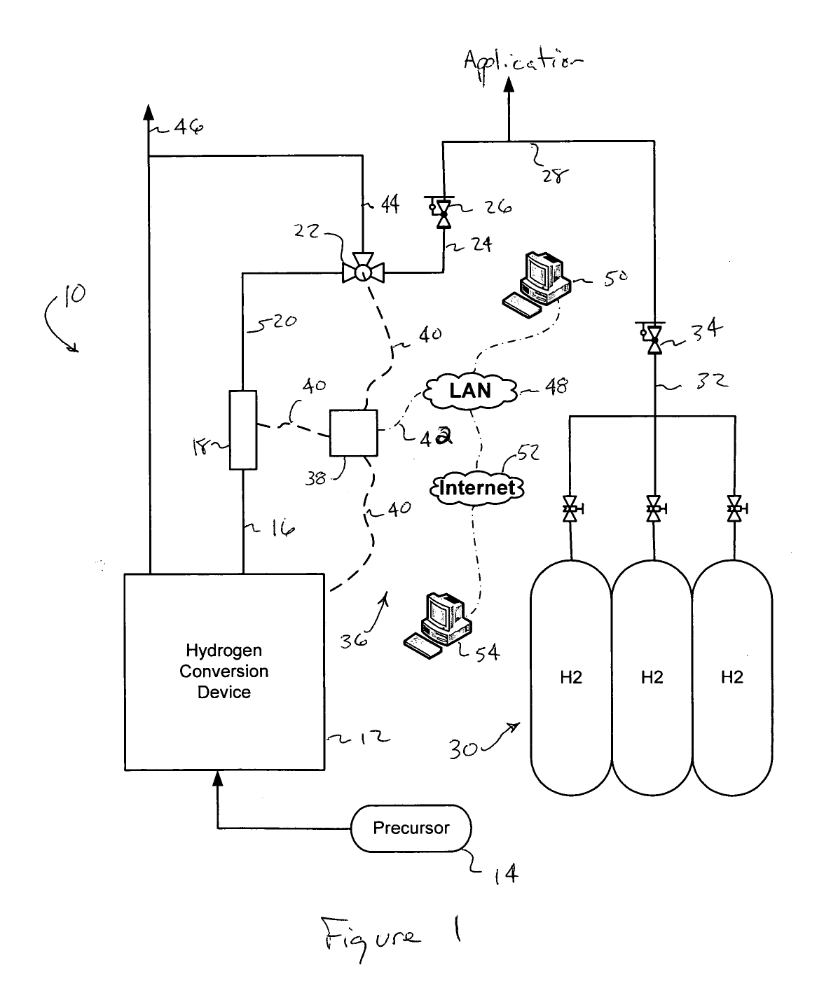

Referring to FIG. 1, a system 10 for providing high purity hydrogen gas is shown. The system 10 includes a hydrogen conversion device 12 that receives a precursor material 14 that is converted to provide hydrogen gas. The hydrogen gas exits the hydrogen conversion device 12 through a conduit 16 where it is interrogated by a sensor before proceeding through conduit 20 to valve 22.

During normal operation, the hydrogen gas will proceed through valve 22 to conduit 24 and through pressure reducing regulator 26. Pressure reducing regulator 26 lowers the pressure of the hydrogen gas from its production pressure to the application pressure needed by the end use application. After the pressure of the gas is reduced, the hydrogen gas stream enters conduit 28. A secondary hydrogen source 30, illustrated in FIG. 1 as a plurality of tanks, is coupled to a conduit 32 that directs the hydrogen through a second pressure reducing regulator 34 that directs the hydrogen gas stream into conduit 28 for delivery to the end use application. As will be described in more detail herein, a control system 36 along with the appropriate setting of the pressure reducing regulators 26, 34 provides the means for switching from hydrogen gas feed stream being utilized by the end use application from the hydrogen conversion device 12 to the secondary hydrogen source 30 in the event that an unacceptable level of contaminant is detected by sensor 18.

The energy conversion device 12 converts a precursor material into hydrogen gas and typically a byproduct material. The precursor material may take many forms, such as water, algae, bacteria, hydrocarbons, oxygenated hydrocarbons, organic carbon materials, fixed metal hydrides, transferable metal hydrides, and sodium borohydroxide. Typically, a different process is used for each different precursor material, as will be described in more detail below, the hydrogen conversion device may include alkaline electrochemical cells, phosphoric acid electrochemical cells, solid oxide electrochemical cells, proton exchange membrane electrochemical cells, steam methane reformer, natural gas reformer, coal reformer, hydrocarbon reformer, partial oxidation reactors, ceramic membrane reactor, photolysis reactor, photoelectrolysis reactor, photochemical reactors, photobiological reactors, anaerobic digesters or bio-mass gasification reactors.

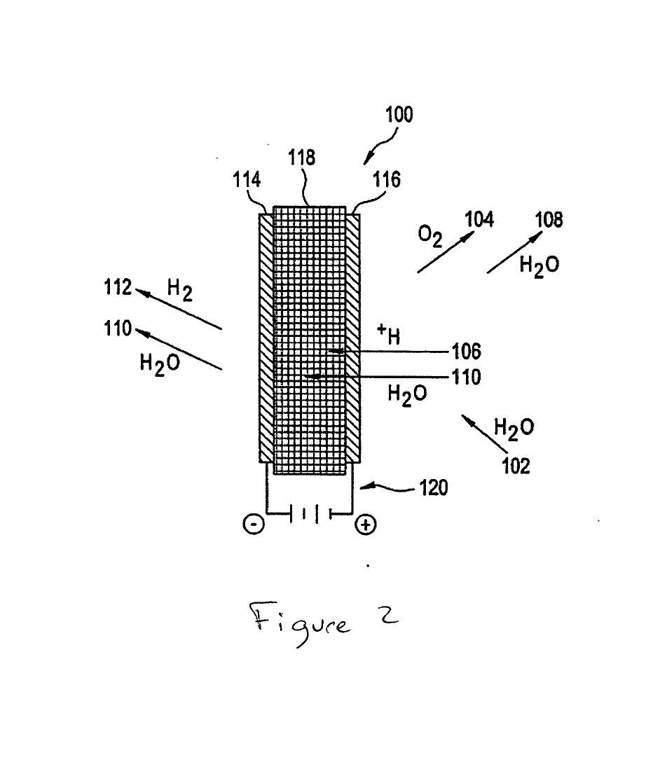

Electrochemical cells are energy conversion devices that may be classified as electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 2, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exits cell 100, while protons 106 and water 110 migrate across a proton exchange membrane 118 to cathode 114 where hydrogen gas 112 is formed.

Another typical water electrolysis cell using the same configuration as is shown in FIG. 2 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

Electrochemical cell systems typically include a number of individual cells arranged in a stack, with the working fluids directed through the cells via input and output conduits formed within the stack structure. The cells within the stack are sequentially arranged, each including a cathode, a proton exchange membrane (PEM), and an anode. The cathode and anode may be separate layers or may be integrally arranged with the membrane. Each cathode/membrane/anode assembly (hereinafter “membrane electrode assembly”, or “MEA”) typically has a first flow field in fluid communication with the cathode and a second flow field in fluid communication with the anode. The MEA may furthermore be supported on both sides by screen packs or bipolar plates disposed within flow fields. Screen packs or bipolar plates may facilitate fluid movement to and from the MEA, membrane hydration, and may also provide mechanical support for the MEA.

In the preferred embodiment, hydrogen conversion device 12 includes the membrane 118 comprised of electrolytes that are preferably solids or gels under the operating conditions of the electrochemical cell. Useful materials include proton conducting ionomers and ion exchange resins. Useful proton conducting ionomers include complexes comprising an alkali metal salt, alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION™ resins (commercially available from E. I. du Pont de Nemours and Company, Wilmington, Del.).

Electrodes 114 and 116 comprise a catalyst suitable for performing the needed electrochemical reaction (i.e., electrolyzing water and producing hydrogen). Suitable catalyst include, but are not limited to, materials comprising platinum, palladium, rhodium, carbon, gold, tantalum, tungsten, ruthenium, iridium, osmium, alloys of at least one of the foregoing catalysts, and the like. Electrodes 114 and 116 can be formed on membrane 118, or may be layered adjacent to, but in contact with, membrane 118.

Alternatively, the hydrogen conversion device 12 may be a simplified electrochemical compressor-type cell. In this embodiment, a hydrogen-water precursor material is introduced into an electrochemical cell having electrodes 114 and 116 comprising a platinum catalyst. The hydrogen in the precursor is permeated through the membrane 118 separating the hydrogen from the water and optionally allowing the hydrogen pressure to be increased simultaneously.

Alternatively, the hydrogen conversion device 12 may be a biomass reactor that uses chemical and/or electrochemical reactions in the production of hydrogen gas. These processes include naturally occurring organic matter with a base. Preferably, the organic matter is biomass. Biomass is a general term used to refer to all non-fossil organic materials that have intrinsic chemical energy content. Biomass includes organic plant matter, vegetation, trees, grasses, aquatic plants, wood, fibers, animal wastes, municipal wastes, crops and any matter containing photosynthetically fixed carbon. Biomass is available on a renewable or recurring basis and is thus much more readily replenished than fossil fuels. The volume of biomass available makes it a naturally occurring carbon resource that is sufficiently plentiful to substitute for fossil fuels.

The capture of solar energy through photosynthesis drives the formation of biomass. During photosynthesis, the organic compounds that make up biomass are produced from CO2 and H2O in the presence of light. The principle compounds present in biomass are carbohydrates. Glucose (C2H12O6) is a representative carbohydrate found in biomass and is formed in photosynthesis through the reaction:
6CO₂+6H₂O [symbol] C₆H₁₂O₆+6O₂

Reactions of organic substances with a base permit the production of hydrogen gas through the formation of carbonate ion and/or bicarbonate by-products. Inclusion of a base as a reactant in the production of hydrogen from organic substances thus provides a reaction pathway for the production of hydrogen. For example, hydrogen may be produced from glucose (C₆H₁₂O₆) through exposure to high temperatures in the following reaction:
C₆H₁₂O₆+6H₂O⇄6CO₂+12H₂

This reaction is representative of reformation reactions of organic substances that are analogous to those used in the reformation of simple compounds such as methanol or ethanol. In another example, hydrogen may be produced from sucrose by reacting it with a base such as sodium hydroxide (NaOH). A representative reaction of sucrose with sodium hydroxide are given below:
C₁₂H₂₂O₁₁+24NaOH+H₂O⇄12Na₂CO₃+24H₂
or
C₁₂H₂₂O₁₁+12NaOH+13H₂O⇄12NaHCO₃+24H₂

Alternatively, similar to the biomass reformation, the hydrogen conversion device 12 may create hydrogen gas through a reaction of carbonaceous matter, such as coal, with a base. Carbonaceous matter refers generally to naturally occurring carbon-containing materials and substances such as coal. Coal typically includes carbon along with various organic and inorganic compounds or elements. Various coals may be used as starting materials in hydrogen-producing reactions, including anthracitic, bituminous, sub-bituminous, and lignitic coals. The primary constinutents of coal are carbon, hydrogen, nitrogen, oxygen and sulfur.

Base facilitated reactions lead to the production of hydrogen from carbonaceous matter. The reactions provide an alternate pathway of carbonaceous matter that leads to a more spontaneous reaction at a particular set of reaction conditions to permit the liberation of hydrogen contained in the carbonaceous matter as hydrogen gas. For example:
C₍ₛ₎+H₂O⇄CO+H₂

Where C₍ₛ₎ refers to the carbon contained in coal. The product mixture of carbon monoxide and H2 gases are known as syngas and can be further reacted to produce other hydrogenated organic fuels such as methanol or ethanol. The carbon monoxide of syngas can be reacted via the water-gas shift reaction to produce additional hydrogen:
CO+H₂O⇄CO₂+H₂

By combining these reactions, a net coal reaction may be written as:
C₍ₛ₎+2H₂O⇄CO₂+2H₂

As with biomass, the addition of a base may also facilitate the generation of hydrogen gas through a reaction that also produces a carbonate or bicarbonate by-product. When sodium hydroxide is combined with the coal, for example:
C₍ₛ₎+2NaOH+H₂O⇄2H₂+NaCO₃
or
C₍ₛ₎+NaOH+2H₂O⇄2H₂+NaHCO

Here, the reaction of a base with coal results in the by-products of either sodium carbonate or sodium bicarbonate with the formation of hydrogen gas.

Alternatively, the hydrogen conversion device 12 may produce hydrogen gas through the reformation of an ammonia precursor. Ammonia may be thermo-catalytically cracked at relatively low temperatures to produce a gas mixture that is 75% hydrogen by volume. The ammonia decomposition reaction may be represented as follows:
2NH₃→N₂+2H₂

Generally, trace amounts of un-reacted ammonia remain in the product stream requiring further purification prior to use.

Alternatively, the hydrogen conversion device 10 may produce hydrogen gas through the reformation of a hydro-carbon based precursor such as natural gas, LPG, gasoline, methanol or diesel. This reformation process typically utilizes a multistep process combined with several clean-up processes. The initial step in the process may be either steam reformation, catalytic reformation, autothermal reformation or catalytic partial oxidation or non-catalytic partial oxidation. Since trace amounts of the precursor material may be found in the resulting gas stream, clean-up processes including desulfurization, high temperature water-gas shift, low temperature water-gas shift, selective CO oxidation, or selective CO methanation are used. Alternatively, processes such as hydrogen selective membrane reactors and filters may be used.

Steam reformation or steam methane reforming is a method of producing hydrogen through the chemical decomposition of water. The hydrogen gas is produced through the introduction of steam at high temperatures, typically 700-1100° C., to methane in the presence of a metal-based catalyst. Typically, the steam reformation process uses natural gas as the source of the methane. This reaction results in carbon mononoxide and hydrogen:
CH₄+H₂O→CO+3H₂

In catalytic reformation, the hydrogen gas is generated as a by-produce to the production of gasoline. This process typically uses a bifunctional catalyst is utilized to rearrange and break the hydrocarbon chains from the hydrocarbon fuel (e.g. oil).

In autothermal reformation, a part of the hydrocarbon fuel is oxidized by controlled addition of oxygen in the presence of oxidation catalysts. The energy which is released during oxidation is necessary for the endothermic steam reformation taking place simultaneously. The temperature which results is between that of partial oxidation and that of steam reformation.

Also, hydrogen may be produced from hydrocarbon based precursors utilizing a process called catalytic partial oxidation. In this process, the hydrocarbon material, such as natural gas, is combined in a reactor with oxygen over a solid catalyst bed. When processed at the proper temperature and ratio of reactants the resultant reaction forms carbon monoxide and hydrogen:
CH₄+½O₂→CO+2H₂

Typically, contaminants such as sulfur are also found in the resulting gas stream and require further post processing to remove the contaminants prior to use.

Alternatively, the hydrogen conversion device may disassociate hydrogen from water through a process known as photolysis. In general, photolysis refers to any chemical reaction through which water is disassociated by light. Typically, the disassociation of water is achieved by subjecting the water to ultraviolet (UV) light in the presence of a catalyst such as titanium dioxide, or tantalum oxide with a co-catalyst nickel oxide. The resultant reaction creates both hydrogen and oxygen gas.

Photolysis may also be utilized with algae through the process of photosynthesis to produce hydrogen gas. Typically, the plant utilizes light from the sun and carbon-dioxide from the air to grow new cells. Through modifications in the algae's environment, the algae may be induced to produce hydrogen rather than oxygen. This process, which typically occurs in a bioreactor, the algae are grown and deprived carbon dioxide and oxygen. This deprivation causes a stress on the algae resulting in a dormant gene becoming activated that results in the synthesis of an enzyme called hydrogenase. The algae use this enzyme to produce both hydrogen and oxygen gas from the surrounding water. The process may be enhanced by creating a sulfur deficient environment as well. As with other hydrogen production methods, post generation processing is required to separate the hydrogen from other gases and contaminants.

One issue with all methods of hydrogen gas generation is the presence of undesired compounds in the resulting gas stream. These compounds may be un-reformed precursor material such as methane or water. Other undesired compounds include reformation byproducts such as carbon monoxide or contaminants found in the precursor material (e.g. sulfur). Since end use applications of hydrogen gas may be sensitive to the introduction of these compounds, it is advantageous to provide a means that automatically detects the undesired compound and takes corrective action to prevent issues or damage to the end use application.

Referring back to FIG. 1, the generated hydrogen gas exits the hydrogen conversion device 12 at a predetermined pressure. The generated pressure may range from 14.7 psi-10,000 psi with a range of 100 psi-200 psi, In the preferred embodiment, the generated pressure is 200 psi. Upon exiting the outlet of the hydrogen conversion device 12, the hydrogen gas enters conduit 16. A sensor 18 is operably coupled to conduit 16 for detecting the undesired compounds in the hydrogen gas stream. The sensor 16 may be of any suitable type that is capable of generating a signal indicative of the level of purity or impurity in the hydrogen gas stream. Examples of impurities that may be measured include but are not limited to carbon monoxide, carbon dioxide, asbestos, sodium hydroxide, sulfur, ammonia, methane, oxygen, water, organic compounds and the like. In the preferred embodiment, the sensor 18 detects the amount of water contained in the gas stream. Preferably, the sensor 18 is an oscillating cylinder type sensor such as Model EXA GD402 manufactured by YOKOGAWA. Alternatively, sensors utilizing thin film aluminum oxide sensors or micromachined silicon sensors may be used. It should be appreciated that while the exemplary embodiment illustrates the sensor 18 as a single component, it may be comprised of several components, or comprised of several sensors each detecting a separate compound and providing a feedback signal to controller 38. Also, it is contemplated that the sensor 18 may be a single component capable of simultaneously measuring multiple compounds.

The sensor 18 is electrically coupled to a controller 38 in the control system 36. The system 10 operation is controlled by controller 38. Controller 38 is a suitable electronic device capable of accepting data and instructions, executing the instructions to process the data, and presenting the results. Controller 38 may accept instructions through user interface, or through other means such as but not limited to electronic data card, voice activation means, manually-operable selection and control means, radiated wavelength and electronic or electrical transfer. Therefore, controller 38 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer, a scientific calculator, or a hybrid of any of the foregoing.

Controller 38 is capable of converting the analog voltage or current level provided by sensor 18 into a digital signal indicative of the level of purity or impurity in the hydrogen gas stream flowing through conduit 16. Alternatively, sensor 18 may be configured to provide a digital signal to controller 38, or an analog-to-digital (A/D) converter (not shown) maybe coupled between sensor 18 and controller 38 to convert the analog signal provided by sensor 18 into a digital signal for processing by controller 38. Controller 38 uses the digital signals act as input to various processes for controlling the system 10. The digital signals represent one or more system 10 data including but not limited to impurity levels, hydrogen conversion operational state, hydrogen gas flow rate, hydrogen gas pressure, valve 22 operational state, secondary hydrogen source operational state and the like.

Controller 38 is operably coupled with one or more components of system 10 by data transmission media 40. Data transmission media 40 includes, but is not limited to, twisted pair wiring, coaxial cable, and fiber optic cable. Data transmission media 40 also includes, but is not limited to, wireless, radio and infrared signal transmission systems. In the embodiment shown in FIG. 1, transmission media 40 couples controller 38 to hydrogen conversion device 12, sensor 18, and valve 22. Controller 38 is configured to provide operating signals to these components and to receive data from these components via data transmission media 40.

In general, controller 38 accepts data from sensor 18 and hydrogen conversion device 12, is given certain instructions for the purpose of comparing the data from sensor 18 to predetermined operational parameters. Controller 38 provides operating signals to hydrogen conversion device 12 and valve 22. Controller 38 also accepts data from hydrogen conversion device 12, indicating, for example, whether the hydrogen conversion device is operating in the correct generation rate and pressure range. The controller 38 compares the operational parameters to predetermined variances (e.g. low flow rate, low pressure, precursor material supply inadequate) and if the predetermined variance is exceeded, generates a signal that may be used to indicate an alarm to an operator or the computer network 42. Additionally, the signal may initiate other control methods that adapt the operation of the system 10 such as changing the operational state of valve 22 to compensate for the out of variance operating parameter. For example, if sensor 18 detects an impurity level above a predetermined threshold, this may indicate an issue with a filtering device in hydrogen conversion device 12. As will be described in more detail below, to prevent damage to the end use application, the controller 38 may initiate a change in operation state signal to valve 22 resulting in the impure gas stream being routed through conduit 44 to vent 46. Another example includes a low precursor material supply that is inadequate for the needs of the end use application. Here again, the controller 29 may initiate a change in state to the valve 22, allowing hydrogen conversion device 12 to disable its operation in an orderly manner without disrupting the flow of hydrogen gas to the end use application.

The data received from sensor 18, hydrogen conversion device 12 and valve 22 may be displayed on a user interface coupled to controller 38. The user interface may be an LED (light-emitting diode) display, an LCD (liquid-crystal diode) display, a CRT (cathode ray tube) display, or the like. A keypad may also be coupled to the user interface for providing data input to controller 38.

In addition to being coupled to one or more components within system 10, controller 38 may also be coupled to external computer networks such as a local area network (LAN) 48 and the Internet. LAN 48 interconnects one or more remote computers 50, which are configured to communicate with controller 38 using a well- known computer communications protocol such as TCP/IP (Transmission Control Protocol/Internet(ˆ) Protocol), RS-232, ModBus, and the like. Additional systems 10 may also be connected to LAN 48 with the controllers 38 in each of these systems 10 being configured to send and receive data to and from remote computers 50 and other systems 10. LAN 48 is connected to the Internet 52. This connection allows controller 38 to communicate with one or more remote computers 54 connected to the Internet 52.

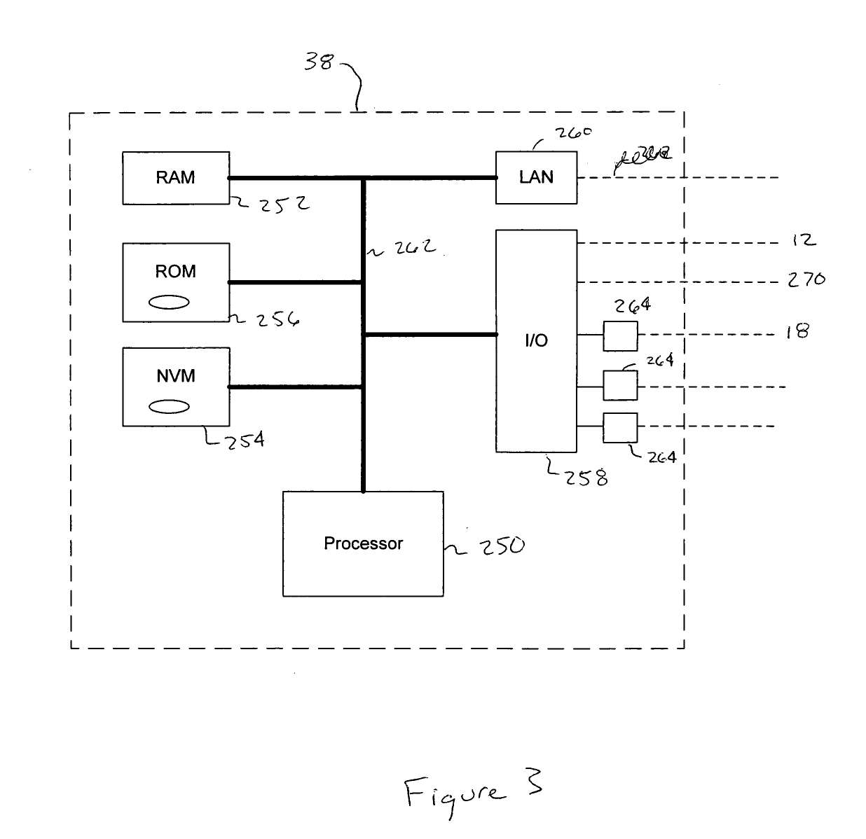

Referring now to FIG. 3, a schematic diagram of controller 38 is shown. Controller 38 includes a processor 250 coupled to a random access memory (RAM) device 252, a non-volatile memory (NVM) device 254, a read-only memory (ROM) device 256, one or more input/output (I/O) controllers 258, and a LAN interface device 260 via a data communications bus 262.

I/O controllers 258 are coupled to hydrogen conversion device 12, and alternatively to a user interface for providing digital data between these devices and bus 262. I/O controllers 258 are also coupled to analog-to-digital (A/D) converters 264, which receive analog data signals from sensor 18.

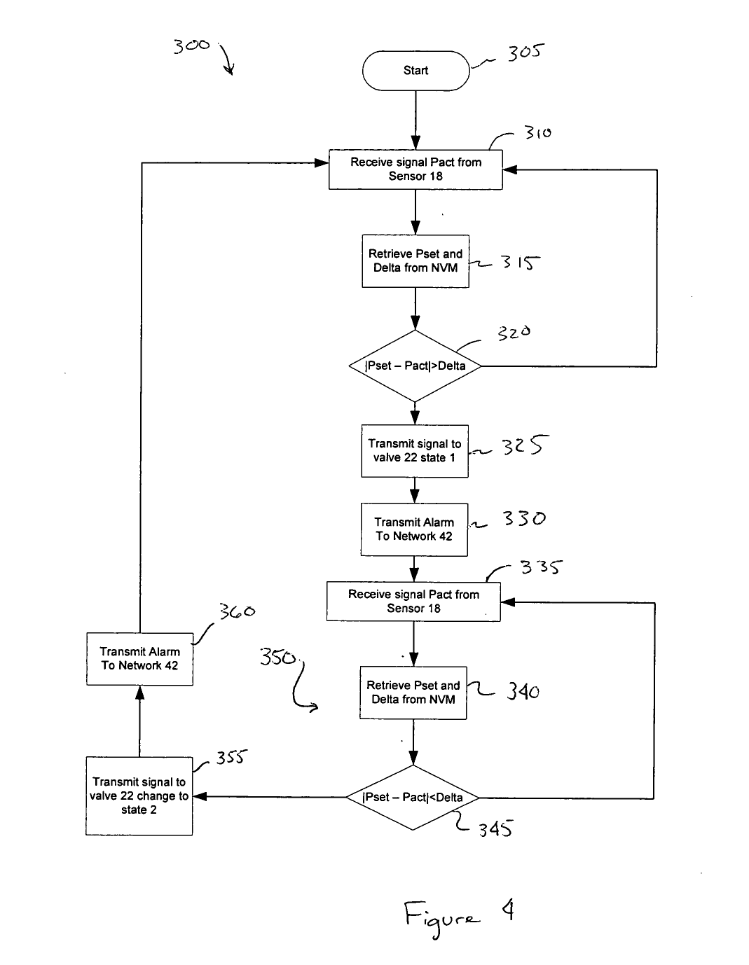

LAN interface device 260 provides for communication between controller 38 and LAN 48 in a data communications protocol supported by LAN 48. ROM device 256 stores an application code, e.g., main functionality firmware, including initializing parameters, and boot code, for processor 250. Application code also includes program instructions as shown in FIG. 4 for causing processor 250 to execute any hydrogen purity system 10 operation control methods, including starting and stopping operation, changing operational states of valve 22, monitoring predetermined operating parameters such as impurity levels in the hydrogen gas, and generation of alarms. The application code creates an onboard telemetry system may be used to transmit operating information between the system 10 and a home terminal location and or/receiving location while en route from the home terminal to a operating location. The information to be exchanged remote computers and the controller 38 include but are not limited to hydrogen purity levels, supply level of precursor material, operational state of hydrogen conversion device 12 and operational state of valve 22.

NVM device 254 is any form of non-volatile memory such as an EPROM (Erasable Programmable Read Only Memory) chip, a disk drive, or the like. Stored in NVM device 254 are various operational parameters for the application code. The various operational parameters can be input to NVM device 254 either locally, using a keypad 270 or remote computer 50, or remotely via the Internet using remote computer 54. It will be recognized that application code can be stored in NVM device 254 rather than ROM device 256.

Controller 38 includes operation control methods embodied in application code shown in FIG. 4. These methods are embodied in computer instructions written to be executed by processor 250, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

Referring to FIG. 4, a high purity hydrogen system output control method 300 will now be described. Method 300 starts at block 305 and proceeds to block 310. At block 310, the digital signal Pact which is indicative of the level of purity in the hydrogen gas stream in conduit 16 is sampled. Method 300 then proceeds to block 315 where the operational parameters Pset and Delta are retrieved from NVM device 254. The operational parameter Pset represents a desired contaminant level. In the preferred embodiment, the sensor 18 is measuring the dew point of the hydrogen gas. Typical values of moisture content for Pset are between 1 ppm and 10 ppm, and preferably between (<1)-5 ppm. The operational parameter Delta represents a contaminant deviance limit relative to Pset. Typical values for Delta are between 2 ppm and preferably between 1 ppm and Delta will vary greatly depending on factors including the contaminant involved and the end use application.

Method 300 continues from block 315 to 320. At block 320, the Pact from block 310 and the values Pset and Delta from block 315 are introduced into the following query at a block 320:
Is|Pact−Pset|>Delta
If the answer to query block 320 is negative then the actual purity is within the allowable variance Delta as compared to the set point purity Pset and method 300 returns to block 310 where the signal Pact is again sampled. This loop continues generally until method 300 is externally terminated or paused or until the query of block 320 is answered affirmatively.

If the answer to the query of block 320 is affirmative, either in the first instance or after one or more negative answers, method 300 proceeds to block 325 wherein a signal is transmitted to valve 22 to change to state 1. When in position state 1, the valve 22 diverts the hydrogen gas flow to conduit 44 which transfers the hydrogen gas to vent conduit 46. In the preferred embodiment, the valve 22 defaults to operation state 1 and requires a 24 VDC signal to maintain positioning in operation state 2 which directs the hydrogen gas to conduit 24. Therefore, in the preferred embodiment, the transmission of the signal to valve 22 by process 300 is accomplished by removing the 24 VDC signal.

After signaling valve 22 to change operational states, process 300 proceeds to optional block 330 where an alarm signal is transmitted via interface device 260 to the network 48 where it may be received by one or more remote computers 50, 54. Process 300 then proceeds on to an optional purge and recycle loop 350. In purge loop 350, the process 300 continues to retrieve a signal Pact from the sensor 18 in block 335. Method 300 then proceeds to block 340 where the operational parameters Pset and Delta are retrieved from NVM device 254.

Method 300 continues from block 340 to 345. At block 345, the Pact from block 310 and the values Pset and Delta from block 340 are introduced into the following query at a block 345:
Is|Pact−Pset|>Delta

If the answer to query block 340 is positive then the actual purity is still outside the allowable variance Delta as compared to the set point purity Pset and method 300 returns to block 335 where the signal Pact is again sampled. Purge loop 350 generally continues to cycle to allow the hydrogen conversion device an opportunity to rectify any issues that may be causing the purity level to fall outside the acceptable range.

If query block 45 is negative, then the purity level has once again returned to the normal operating range and process 300 continues on to block 355. In block 355, process 300 transmits a signal to valve 22 to initiate a change to operational state 2 allowing hydrogen gas to flow once again to conduit 24. Process 300 proceeds on to block 360 where an optional alarm/message is transmitted over the network 42 to remote computers 50, 54 that hydrogen conversion device 12 has returned to a normal operation state.

The high purity hydrogen system output control method and apparatus described herein allows operational parameters for the system 10 to be set either remotely or locally. Because the operational parameters can be set remotely, a single operator can monitor and control any number of high purity hydrogen systems from virtually any location. The remote setting of operational parameters provides an operational convenience that was previously unattainable with prior art system. Additionally, the present invention provides man-power and cost savings over the prior art because a single operator can monitor and operate any number of systems located at different sites. This single operator may then dispatch additional hydrogen supplies or repair personnel depending on the operating state and issues being experienced by the system 10.

The high purity hydrogen system output control methods can be embodied in the form of computer-implemented processes and apparatuses for practicing those processes. The output control methods may also be embodied in the form of computer program code containing instructions, embodied in tangible media, such as floppy diskettes, CD-ROMS, DVD's, flash-memory, hard drives, or any other computer readable storage medium, wherein, when the computer program code loaded into and executed by a computer, the computer becomes an apparatus for practicing the invention. The output control methods can also be embodied in the form of computer program code, for example, whether stored in a storage medium, loaded into and/or executed by a computer, or transmitted over some transmission medium, such as over electrical wiring or cabling, through fiber-optics, or via electromagnetic radiation, wherein, when the computer program code is loaded into and executed by a computer, the computer becomes an apparatus for practicing the invention. When the implementation is on a general-purpose microprocessor, the computer program code segments configure the microprocessor to create specific logic circuits.

If the purity levels of the hydrogen gas stream in conduit 16 are within the normal operating range, the hydrogen flows through valve 22. The valve 22 being positioned in operational state 2 allows the hydrogen gas to flow through conduit 24 to pressure reducing regulator 26. Regulator 26 may be any type of gas pressure regulator that reduces the gas stream from high-pressure to low-pressure and controls the low or outlet pressure, typically with one stage of pressure reduction. Optionally, regulator 26 may be a flow type regulator that controls the volume of gas flowing through the conduit 24. The regulator 26 may have a fixed pressure reduction setting or, the operator may set the operational parameter pressure reduction. In the preferred embodiment, the output pressure of hydrogen conversion device 12 is 200 psi, regulator 26 further adapts this pressure to that required by the end use application, typically between 50 and 200 psi, and more preferably 100 psi. In the case of fuel cell vehicle fueling applications, the hydrogen conversion device output pressure may be as high as 10,000 psi, with a regulator 26 adjusting the final pressure to between 5000 psi to 6000 psi.

The reduced pressure hydrogen is then transferred through conduit 28 to the end use application. A secondary hydrogen source 30 is connected to the end use application in parallel with the hydrogen conversion device. The secondary hydrogen source provides the hydrogen gas at a pressure higher than that in conduit 28. In the preferred embodiment, the secondary hydrogen source 30 is at least one, and preferably a plurality of high pressure compressed hydrogen storage tanks that contain hydrogen gas compressed to 2400 psi. The secondary hydrogen gas is transferred via conduit 32 to pressure reducing regulator 34. Regulator 34 may have either a fixed or adjustable pressure reduction operational parameter. In either case, regulator 34 is set to reduce the pressure of the secondary hydrogen gas in conduit 32 to a pressure that is lower than the gas pressure leaving regulator 26. In the preferred embodiment, regulator 34 is set to a pressure at least 5 psi lower than regulator 26 and more preferably regulator 34 is 10 psi lower than regulator 26. By setting the regulator 34 at a lower operating parameter than regulator 26, the regulator 34 will behave like a check valve preventing the secondary hydrogen gas from flowing through the regulator 34 into conduit 28. Therefore, in the event that the position of valve 22 is moved from operating state 2 to operating state 1, the gas pressure in conduit 28 will decrease, allowing the secondary hydrogen gas to automatically and immediately start providing a hydrogen gas stream to the end use application. This automatic and immediate cross over of hydrogen gas supplies was virtually unattainable in prior art systems that required the activation and communication between powered valves resulting in an inherent latency in the switch to a secondary supply.

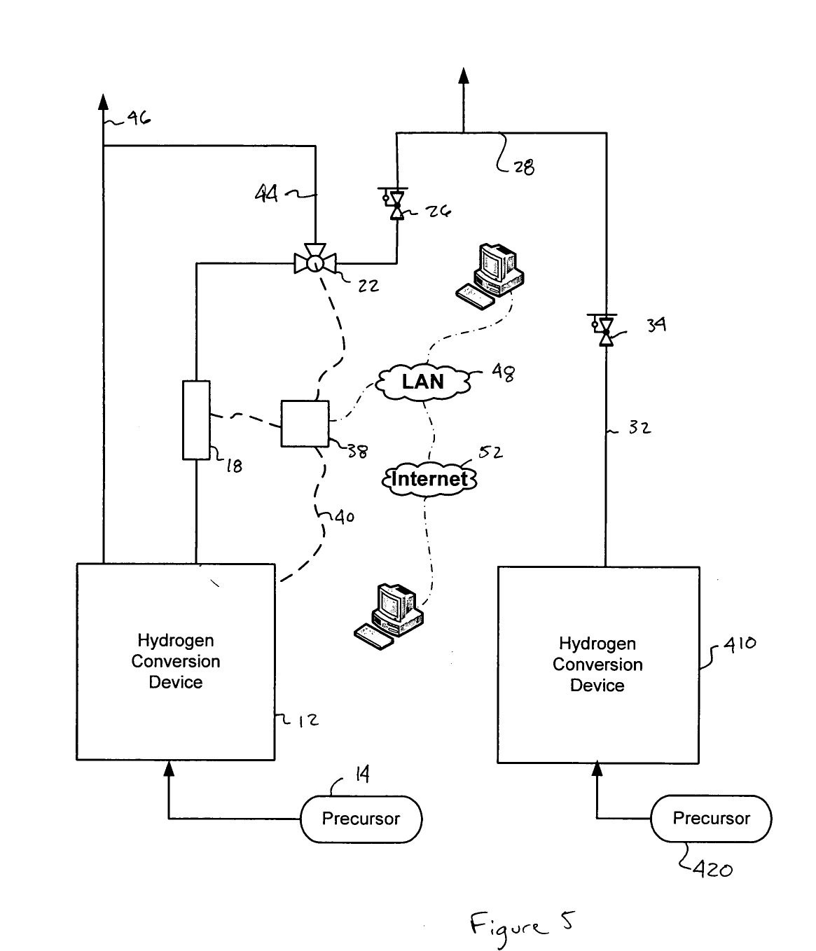

An alternate embodiment high purity hydrogen system is shown in FIG. 5. In this embodiment, the secondary hydrogen source 30 is another hydrogen conversion device 410. The hydrogen conversion device 410 receives a precursor material 420 from which the hydrogen gas is produced. The hydrogen conversion device 410 may be any of the types described above. In the preferred embodiment, the hydrogen conversion device 410 is a PEM electrolysis system and the precursor material 420 is water. Optionally a sensor and controller (not shown), similar to that described above may be incorporated for operation with hydrogen conversion device 410 for additional protection of the end use application.

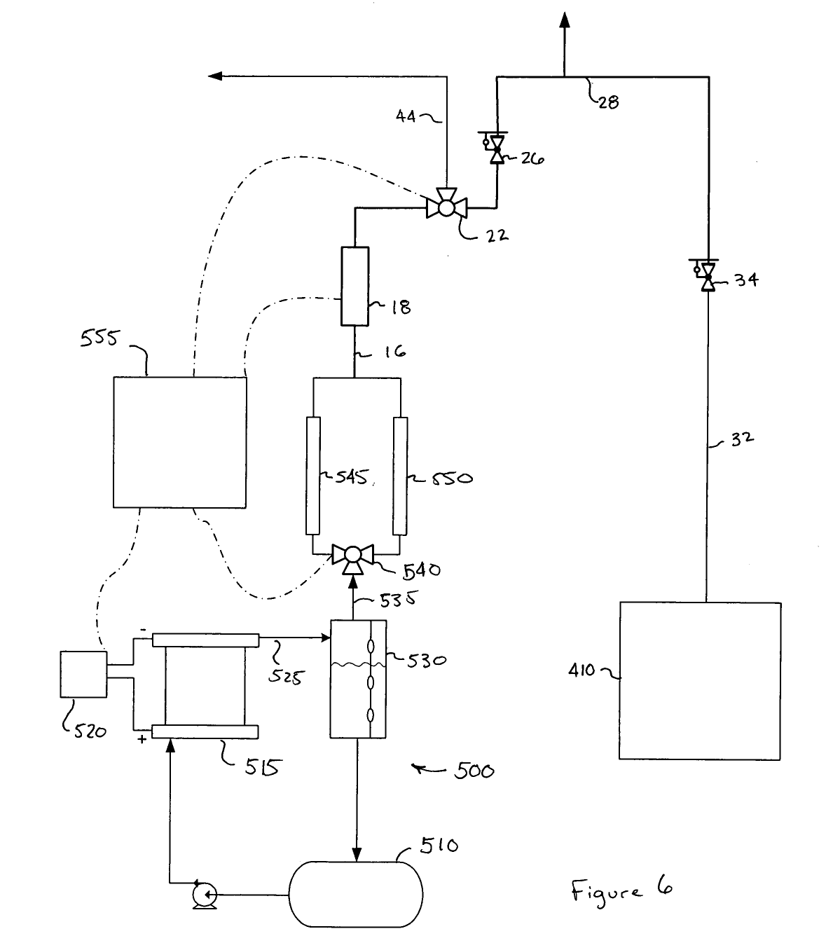

Another alternate embodiment high purity hydrogen system is shown in FIG. 6. In this embodiment, the hydrogen conversion device 12 is a PEM electrolysis system 500. Water is removed from either a storage vessel 510 or a similar supply and transferred to a PEM electrochemical cell stack 515. The electrical current is provided by power supply 520, the cell stack 515 disassociates the hydrogen and oxygen from the water forming hydrogen and oxygen gas. The hydrogen protons permeate across the membranes in the cell stack 515 and exit via conduit 525. A mixture of hydrogen gas and water enter a phase separator 530 where due to the reduction in pressure and under the effect of gravity, the water falls to the bottom of the separator 530 where it is removed to vessel 510.

The hydrogen gas exits the separator 530 through conduit 535 and enters valve 540. Depending on the setting of valve 540, the hydrogen gas stream will either enter filtering device 545 or filtering device 550. Filtering devices 550 may be of any suitable type to remove the contaminants in the hydrogen gas stream. In the preferred embodiment, the filtering devices 545, 550 are desiccant packed columns having a suitable material for absorption of water. Alternatively, the filtering devices may be a hydrogen selective palladium membrane system or a single bed of dessicut or hydride material.

The hydrogen gas stream exits one of the filtering devices 545, 550 and enters conduit 16 where sensor 18 montors the purity level of the gas stream and produces a signal to controller 555 in the same manner as was described herein above with respect to FIG. 1. Controller 555 is operably coupled to the power supply 520 and the valve 540. When an inappropriate level of impurity is detected by sensor 18, controller 555 signals valve 540 to switch the hydrogen gas stream from filtering device 545 to filtering device 550. In the preferred embodiment, a small stream of the filtered hydrogen that is being processed by filtering device in current use would be fed back into the unused filtering device to allow the regeneration of the desiccant material contained therein.

Controller 555 may also take additional operational steps as necessary. For example, if the purity level remains at an unacceptable level for a predetermined amount of time, controller 555 may signal the power supply to change operational parameters to change the output of hydrogen gas from the cell stack 515. In an extreme condition, the controller 555 may signal the power supply 520 to stop providing power to the cell stack 515 halting the hydrogen generation. It should be appreciated that the controller 555 may be a single device as illustrated, or may be comprised on multiple electrically coupled controllers each having a distinct function.

While the invention has been described with reference to a preferred embodiment, it will be understood by those skilled in the art that various changes may be made and equivalents may be substituted for elements thereof without departing from the scope of the invention. In addition, any modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A system for providing high purity hydrogen comprising:
a hydrogen conversion device having means for converting a hydrogen precursor into gaseous hydrogen at a predetermined first pressure, said hydrogen conversion device having at least one outlet;
a first pressure regulator fluidly coupled to said hydrogen conversion device outlet, said first regulator having a predetermined operating parameter set at a second pressure;
a second pressure regulator having a predetermined operating parameter set at a third pressure wherein said third pressure is lower than said second pressure;
a second hydrogen source fluidly coupled to said second regulator, said second hydrogen source containing a first quantity of pressurized hydrogen gas at a fourth pressure; and,
a junction fluidly coupled to said first and second regulator.

2. The system for providing high purity hydrogen of claim 1 further comprising a valve positioned between said first regulator and said hydrogen conversion device, said valve having a first inlet fluidly coupled to said hydrogen conversion device and a first outlet fluidly coupled to said first regulator.

3. The system for providing high purity hydrogen of claim 2 wherein said valve further includes a second outlet wherein said valve may be actuated to direct hydrogen gas to said first or second outlet in response to a signal.

4. The system for providing high purity hydrogen of claim 3 wherein said valve is configured to direct hydrogen gas to said second outlet in the absence of an actuating signal.

5. The system for providing high purity hydrogen of claim 4 further comprising a sensor fluidly coupled between said valve and said hydrogen conversion device, said sensor producing a first signal.

6. The system for providing high purity hydrogen of claim 5 comprising a controller electrically coupled to said sensor and said valve, said controller producing a second signal in response to said first signal exceeding a predetermined threshold.

7. The system for providing high purity hydrogen of claim 6 wherein said controller is electrically coupled to said hydrogen conversion device and said controller produces a third signal in response to said first signal exceeding a predetermined threshold.

8. The system for providing high purity hydrogen of claim 7 wherein said hydrogen conversion device is selected from a group consisting of alkaline electrochemical cells, phosphoric acid electrochemical cells, solid oxide electrochemical cells, proton exchange membrane electrochemical cells, steam methane reformer, natural gas reformer, coal reformer, hydrocarbon reformer, partial oxidation reactors, ceramic membrane reactor, photolysis reactor, photoelectrolysis reactor, photochemical reactors, photobiological reactors, anaerobic digesters or bio-mass gasification reactors.

9. The system for providing high purity hydrogen of claim 8 wherein said hydrogen conversion device is a polymer electrode membrane electrochemical cell.

10. The system for providing high purity hydrogen of claim 2 wherein said second hydrogen source is a second hydrogen conversion device.

11. The system for providing high purity hydrogen of claim 10 wherein said hydrogen conversion device is selected from a group consisting of alkaline electrochemical cells, phosphoric acid electrochemical cells, solid oxide electrochemical cells, proton exchange membrane electrochemical cells, steam methane reformer, natural gas reformer, coal reformer, hydrocarbon reformer, partial oxidation reactors, ceramic membrane reactor, photolysis reactor, photoelectrolysis reactor, photochemical reactors, photobiological reactors, anaerobic digesters or bio-mass gasification reactors.

12. The system for providing high purity hydrogen of claim 11 wherein said hydrogen conversion device is a proton exchange membrane electrochemical cell.

13. The system for providing high purity hydrogen of claim 2 wherein said second hydrogen source is a vessel.

14. The system for providing high purity hydrogen of claim 13 wherein said vessel contains compressed hydrogen gas.

15. The system for providing high purity hydrogen of claim 13 wherein said vessel contains a metal hydride.

16. A system for providing high purity hydrogen comprising:
a hydrogen conversion device having means for converting a hydrogen precursor into gaseous hydrogen at a predetermined first pressure, said hydrogen conversion device having at least one outlet;
a first pressure regulator fluidly coupled to said hydrogen conversion device outlet, said first regulator having a predetermined first operating parameter set at a second pressure;
a second pressure regulator fluidly coupled to said first regulator, said second regulator having a predetermined second operating parameter set at a third pressure wherein said third pressure is lower than said second pressure;
a vessel fluidly coupled to said second regulator, said second regulator containing a first quantity of pressurized hydrogen gas at a fourth pressure;
a valve having a valve inlet fluidly coupled to said hydrogen conversion device outlet, a first valve outlet fluidly coupled to said first regulator and a second valve outlet; and,
a controller electrically coupled to said valve and said hydrogen conversion device, wherein said controller transmits a first signal to said valve to direct hydrogen gas from said second outlet to said first outlet.

17. The system for providing high purity hydrogen of claim 16 further comprising a sensor fluidly coupled to said hydrogen conversion device outlet and said valve inlet, said sensor being electrically coupled to said controller and transmitting a second signal to said controller indicative of the purity parameter of said hydrogen gas being generated by said hydrogen conversion device.

18. The system for providing high purity hydrogen of claim 17 wherein said purity parameter is the dew point of said hydrogen gas being generated by said hydrogen conversion device.

19. The system for providing high purity hydrogen of claim 17 wherein said purity parameter is quantity of water in said hydrogen gas being generated by said hydrogen conversion device.

20. The system for providing high purity hydrogen of claim 17 wherein said third pressure is at least 5 psi lower than said second pressure.

21. The system for providing high purity hydrogen of claim 20 where said third pressure is 10 psi lower than said second pressure.

22. The system for providing high purity hydrogen of claim 17 wherein said second pressure is less than 130 psi.

23. The system for providing high purity hydrogen of claim 22 wherein said hydrogen conversion device is selected from a group consisting of alkaline electrochemical cells, phosphoric acid electrochemical cells, solid oxide electrochemical cells, proton exchange membrane electrochemical cells, steam methane reformer, natural gas reformer, coal reformer, hydrocarbon reformer, partial oxidation reactors, ceramic membrane reactor, photolysis reactor, photoelectrolysis reactor, photochemical reactors, photobiological reactors, anaerobic digesters or bio-mass gasification reactors.

24. The system for providing high purity hydrogen of claim 23 wherein said hydrogen conversion device is a proton exchange membrane electrochemical cell.

25. The system for providing high purity hydrogen of claim 24 wherein said first pressure is greater than 100 psi.

26. The system for providing high purity hydrogen of claim 17 wherein said controller includes a processor, wherein said processor is programmed for:
receiving said second signal from said sensor;
retrieving a first operational parameter and a predetermined variance from a memory device electrically coupled to said processor;
comparing said first operational parameter to said second signal; and,
terminating said first signal if said second signal differs from said first operation parameter by more than said predetermined variance.

27. The system for providing high purity hydrogen of claim 26 wherein said process is programmed for:
providing a third signal if said second signal differs from said first operation parameter by more than said predetermined variance; and,
transmitting said third signal to said hydrogen conversion device.

28. A method for providing high purity hydrogen comprising:
generating hydrogen gas from a first precursor;
monitoring said hydrogen gas for an impurity level;
transferring said hydrogen to a first conduit if said impurity level is below a first operational parameter;
transferring said hydrogen to a second conduit if said impurity level is above said first operation parameter;
setting a first pressure reducing regulator to a first pressure wherein said first pressure reducing regulator is coupled to said first conduit;
transferring said hydrogen gas to a third conduit wherein said third conduit is fluidly coupled to said first regulator opposite said first conduit; and,
setting a second pressure reducing regulator to a second pressure wherein said second pressure reducing regulator is fluidly coupled to said third conduit.

29. The method of providing high purity hydrogen of claim 28 further comprising the step of transmitting a signal if said impurity level is above said operational parameter.

30. The method of providing high purity hydrogen of claim 29 wherein said third pressure is lower than said second pressure.

31. The method of providing high purity hydrogen of claim 30 wherein said third pressure is 5 psi or lower than said second pressure.

32. The method of providing high purity hydrogen of claim 29 further comprising the steps of:
providing hydrogen gas from a second source at a fourth pressure wherein said fourth pressure is greater than said second pressure;
transferring said second source hydrogen gas to a fourth conduit fluidly coupled to said second pressure reducing regulator.

33. The method of providing high purity hydrogen of claim 32 further comprising the steps of:
transferring hydrogen gas to said second conduit in response to said signal; and,
transferring said second source hydrogen gas to said third conduit.

34. The method of providing high purity hydrogen of claim 28 further comprising the step of providing hydrogen gas from a second hydrogen source if said generated hydrogen gas is transferred to said second conduit.

35. The method of providing high purity hydrogen of claim 34 wherein said second hydrogen source generates hydrogen gas from a second precursor.

36. The method of providing high purity hydrogen of claim 35 wherein said first precursor is the same as said second precursor.

37. A method for providing high purity hydrogen comprising:
generating hydrogen gas with a first hydrogen source from a first precursor;
monitoring said hydrogen gas for an impurity level;
transferring said hydrogen gas to a first conduit if said impurity level is below a first operational parameter;
transferring said hydrogen to a second conduit if said impurity level is above said first operation parameter;
if said impurity level is above said first operational parameter then iteratively performing the following steps a-d:
a. providing hydrogen gas from a second hydrogen source;
b. providing a signal to said first hydrogen source;
c. filtering said first source hydrogen gas;
d. monitoring said filtered hydrogen gas for an impurity level; and,
e. transferring hydrogen gas to said first conduit if said impurity level is below said first operational parameter.

38. The method of providing high purity hydrogen of claim 37 further wherein said second hydrogen source generates hydrogen from a second precursor.

39. The method of providing high purity hydrogen of claim 38 further comprising the steps of:
monitoring said hydrogen gas generated by said second hydrogen source for a second impurity level;
transferring said hydrogen gas generated by said second hydrogen source to a first conduit if said second impurity level is below a second operational parameter;
transferring said hydrogen to a third conduit if said second impurity level is above said second operation parameter;
if said second impurity level is above said second operational parameter then iteratively performing the following steps a-d:
a. providing hydrogen gas from a third hydrogen source;
b. providing a signal to said second hydrogen source;
c. filtering said second hydrogen source hydrogen gas;
d. monitoring said filtered second hydrogen source hydrogen gas for a second impurity level; and,
e. transferring said second hydrogen source hydrogen gas to said first conduit if said second impurity level is below said first operational parameter.

40. A computer implemented apparatus for controlling the delivery of high purity hydrogen comprising:
a power supply;
an electrochemical cell electrically coupled to said power supply for supplying energy to said electrochemical cell, said electrochemical cell supplying hydrogen gas to an outlet;
a first conduit fluidly coupled to said electrochemical cell outlet;
a first valve coupled to said first conduit, said first valve being operable between a first position coupled to a first output and a second position coupled to a second output;
a first filtering device fluidly coupled to said first valve first output;
a second filtering device fluidly coupled to said first valve second output;
a second conduit fluidly coupled to said first and second filtering devices
a sensor fluidly coupled to said second conduit for generating a signal indicative of the purity level of said hydrogen gas in said conduit;
a second valve fluidly coupled to said second conduit, said second valve being operable between a first position coupled to a first output and a second position coupled to a second output;
a third conduit electrically coupled to said controller and fluidly coupled to said second valve first output;
a hydrogen source fluidly coupled to said third conduit;
a controller coupled to said power supply for delivering a first control parameter to said power supply to alter the supply of energy to said electrochemical cell, said processor being further coupled to said first valve for delivering a second control parameter to said valve to selectively move said first valve between said first and second position, said processor being further coupled to said second valve for delivering a third control parameter to said second valve to selectively move said second valve between said first and second position;
wherein said controller changes said second and third control parameters if said signal indicates to purity level is below a predetermined threshold.
